(19) United States
(12) Patent Application Publication
(10) Pub. No.: US 2008/0027899 A1
(43) Pub. Date: Jan. 31, 2008

(54) Systems and Methods for Integrating from Data Sources to Data Target Locations

(75) Inventors: Sandeep Khunteta, Mohali (IN); Amrit Pal Singh, Mohali (IN)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(73) Assignee: QUARK, INC., Denver, CO (US)

(21) Appl. No.: 10/560,546

(22) PCT Filed: Aug. 9, 2005
(86) PCT No.: PCT/US05/28298

§ 371 Date: Dec. 12, 2005

(51) Int. Cl. G06F 7/06; G06F 17/30

(52) U.S. Cl. 707/2; 707/E17.005; 707/E17.125

(57) ABSTRACT

Various systems and methods for data exchange are provided. As just one example, a method for data exchange that includes identifying at least one target data receptacle and at least two source data receptacles are described. In addition, the exemplary method includes providing a map that includes a relationship between a source element of one of the source data receptacles and a target element of the target data receptacle, and between a source element of another source data receptacle and another target element of the target data receptacle.

### BACKGROUND OF THE INVENTION

The present invention relates to systems and methods for data production and distribution, and in particular to systems and methods for gathering and maintaining data.

Traditionally, managing data has involved inputing data to and accessing data from a database. Thus, for example, a company may develop a database including information about all of its employees. It is often time consuming to enter the information, and the information represents a significant investment. To protect this investment, tools have been developed that allow the database to be updated or migrated. One example of such a product is the Data Integration Toolkit version three offered by Quark, Inc. In particular, the aforementioned Data Integration Toolkit provides support for transforming data from single source data repository to single target data repository. Further, the aforementioned Data Integration Toolkit provides a graphical interface limited to exchanging data between one source and one destination. While this toolkit is useful, it is limited to migrating, between on data source and one data target.

Hence, for at least the aforementioned reasons, there exists a need in the art for advanced systems and methods to address the needs of the industry.

### BRIEF SUMMARY OF THE INVENTION

The present invention relates to systems and methods for data production and distribution, and in particular to systems and methods for gathering and maintaining data.

Some embodiments of the present invention provide methods for data exchange. The methods include identifying at least one target data receptacle and at least two source data receptacles. In addition, the methods include providing a map that includes a relationship between a source element of one of the source data receptacles and a target element of the target data receptacle, and between a source element of another source data receptacle and another target element of the target data receptacle. In some cases, the methods further include designing the target data receptacle. Designing the target data receptacle includes providing a name for the target data elements. Designing the target data receptacle may further include providing a relationship between the target elements. In one particular instance of the embodiments, the target data receptacle is an XML file defined by an XML schema.

In various cases, the methods further include providing a graphical interface that depicts a representation of the target receptacle, and a representation of the source receptacles. In such cases, the methods include receiving instructions via the graphical interface to map the source elements from the source data receptacles to the target data receptacle. In such cases, the map may be formed based at least in part on the received instructions. In one or more instances of the embodiments, the methods further include applying the map. By applying the map, information from the source data receptacles is transferred to the target receptacle in accordance with the map.

Other embodiments of the present invention provide systems for exchanging data. The systems include a microprocessor and a computer readable medium. The computer readable medium includes instructions executable by the microprocessor to: receive an indication of a target data receptacle, and an indication of at least two source data receptacles. In addition, the instructions executable by the microprocessor to provide a map include a relationship between a source elements from the different source data receptacles, and corresponding target elements of the target data receptacle.

This summary provides only a general outline of some embodiments according to the present invention. Many other objects, features, advantages and other embodiments of the present invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 depicts a system for data exchange in accordance with one or more embodiments of the present invention;

FIG. 2 is a graphical representation of a data exchange system in accordance with various embodiments of the present invention;

FIG. 3 is a flow diagram showing a method for data exchange in accordance with one or more embodiments of the present invention;

FIG. 4 depict a graphical tool used for data exchange in accordance with a variety of embodiments of the present invention;

FIG. 5 depict another graphical tool used for data exchange in accordance with other embodiments of the present invention where common data elements are combined and used as a guide for assembling a target data structure.

### DETAILED DESCRIPTION OF THE INVENTION

The present invention relates to systems and methods for data production and distribution, and in particular to systems and methods for gathering and maintaining data.

Various embodiments of the present invention provide systems and methods for data exchange. One exemplary method in accordance with embodiments of the present invention includes identifying at least one target data receptacle and at least two source data receptacles. As used herein, the term “data receptacle” is used in its broadest sense to mean any repository of data. Thus, for example, a data receptacle may be, but is not limited to, a database server or a hard disk drive that is formatted to accept information. In addition, the method involves providing a map that includes a relationship between a source element of one of the source data receptacles and a target element of the target data receptacle, and between a source element of another source data receptacle and another target element of the target data receptacle. In some cases, the methods further include designing the target data receptacle. Designing the target data receptacle includes providing a name for the target data elements. Designing the target data receptacle may further include providing a relationship between the target elements. In one particular instance of the embodiments, the target data receptacle is an XML file defined by an XML schema. Based on the disclosure provided herein, however, one of ordinary skill in the art will recognize other files and/or schema types to which embodiments of the present invention may be applied.

Some embodiments of the present invention provide capability to view metadata of more than one data source, as well as a capability to map one or more data sources to one or more target stores. Thus, embodiments of the present invention may provide for mapping and/or merging multiple sources to multiple targets, multiple sources to one target, and/or one source to multiple targets. In these embodiments, a user can define relationships between fields of different data sources (e.g., a database column with a field in a delimited text file). After the relationships have been prepared, a user may be presented with a merged (hierarchical) view of source data, which the user can map to any of various target fields. Then, the merge may be completed in accordance with the aforementioned relationships. The merge may be done by merging information coming from multiple data sources in accordance with an association rule set up by the user and the mapping rules will then be applied to the merged data. Further, in some cases, a user may be able to specify if any field of a source metadata contains some data that shall be parsed using some other program. In such a case, the parsed metadata may be shown as part of original metadata hierarchy allowing a user to map data fields from original metadata as well as the parsed content metadata.

In one particular embodiment of the present invention, mappings defined in a data production engine or data mapper is converted to a standard XSL file where the data is a single XML stream in accordance with the merged structure of the actual data sources. During the data transfer process, the embodiment internally converts data received from various data sources to XML streams and then all these streams are merged to create a single and consolidated intermediate XML stream. The mapper generated XSL is applied over the aforementioned XML stream to generate an intermediate XML stream, which is then converted to target data structures and then imported to target data repositories.

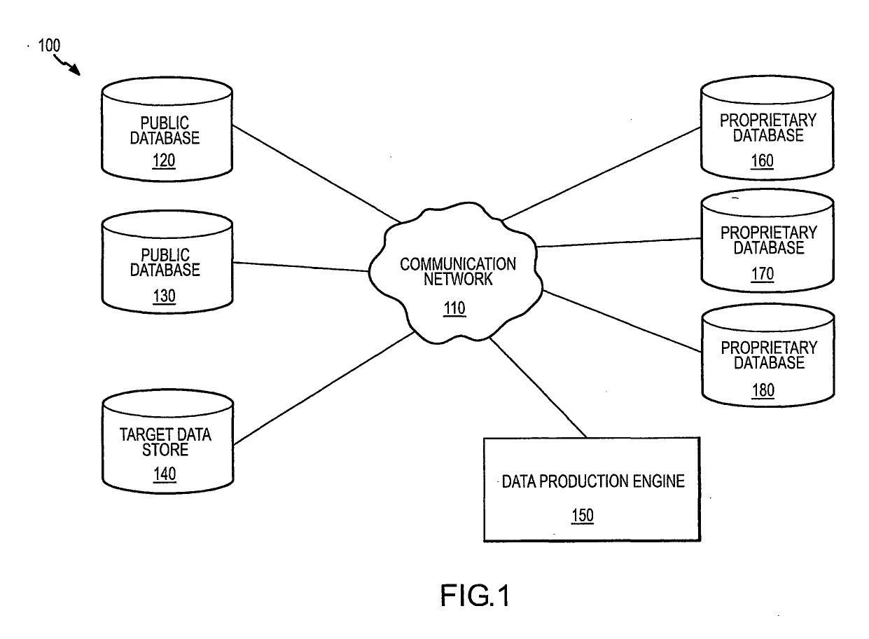

Turning to FIG. 1, a system 100 for data exchange in accordance with one or more embodiments of the present invention is illustrated. System 100 includes various data receptacles including public database 120, public database 130, proprietary database 160, proprietary database 170, proprietary database 180, and target data store 140. Proprietary databases 160, 170, 180 may include, but are not necessarily limited to, information that is available to only a limited subset of users. Thus, an employee database is one example of a proprietary database. In contrast, public databases 120, 130 may include, but are not necessarily limited to, information that is accessible to a broad range of users. Thus, for example, a library catalog or an Internet website are public databases. The aforementioned information sources are merely exemplary, and based on the disclosure provided herein, one of ordinary skill in the art will appreciate a variety information sources that can be utilized in accordance with embodiments of the present invention.

In addition, system 100 includes a data production engine 150. As illustrated, data production engine 150 is communicably coupled to the various data receptacles via a communication network 110. As used herein, the term “communicably coupled” is used in its broadest sense to mean any approach or mechanism whereby information may be exchanged between devices. Thus, for example, communication network may be, but is not limited to, the Internet, a virtual private network, an optical network, a cellular telephone network, a public switched telephone network, a wire between devices, combinations of the aforementioned, and/or the like.

Data production engine 150 may be any microprocessor based tool capable of communicating with one or more of the data receptacles via communication network 110. In one particular instance, data production engine 150 is a personal computer executing software instructions. Based on the disclosure provided herein, one of ordinary skill in the art will appreciate a variety of microprocessor based systems capable of providing the functionality associated with data production engine 150.

In operation, data production engine 150 receives a schema for a target data source that may be maintained on target data store 140. The map indicates a relationship between elements in the schema and elements from various of public database 120, public database 130, proprietary database 160, proprietary database 170, and proprietary database 180. As just one example, a field in proprietary database 160 may include an employee's name, a field in proprietary database 170 may include an employee's current compensation, a field in proprietary database 180 may include company products represented by a particular employee, and public databases 120, 130 may include a field that provides public marketing information about company products. The map associates these respective fields from databases 120, 130, 160, 170, 180 with corresponding fields in the target schema that may be maintained on target data store 140.

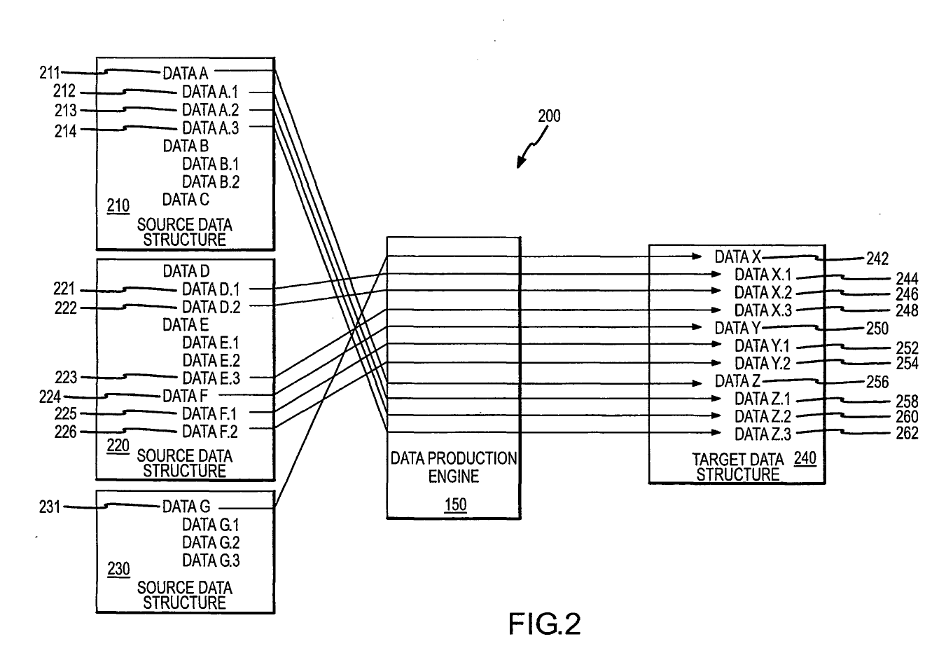

Turning to FIG. 2, a graphical representation 200 of a data exchange system in accordance with various embodiments of the present invention is illustrated. Graphical representation 200 includes a depiction of a source data structure 210, a source data structure 220, and a source data structure 230. In addition, data production engine 150 is depicted transferring information to a target data structure 240. As illustrated, source data structure 210 includes, among others, data element A 211, data element A.1 212, data element A.2 213, and data element A.3 214. Source data structure 220 includes, among others, data element D.1 221, data element D.2 222, data element E.3 223, data element F 224, data element F.1 225, and data element F.2 226. Source data structure 230 includes, among others, data element G 231. Target data structure 240 includes a data element X 242, a data element X.1 244, a data element X.2 246, data element X.3 248, data element Y 250, data element Y.1 252, data element Y.2 253, data element Z 256, data element Z.1 258, data element Z.2 260, and data element Z.3 262.

Data production element 150 implements a map graphically portrayed as lines between respective data elements on graphical representation 200. In the depicted situation, the map causes information associated with data element G 231 to be merged in target data structure 240 as data element X 242. Similarly, data elements D.1 221, D.2 222, E.3 223, F 224, F.1 225, and F.2 226 of source data structure 220 are respectively merged in target data structure 240 as data elements X.1 244, X.2 246, X.3 248, Y 250, Y.1 252, and Y.2 254. Data elements A 211, A.1 212, A.2 213, and A.3 214 of source data structure 210 are respectively merged in target data structure 240 as data elements Z 256, Z.1 258, Z.2 260, and Z.3 262. In a typical scenario, source data structure 210, source data structure 220, and source data structure 230 may be associated with a public database or a proprietary database. Target data structure 240 may be associated with a target data store. Based on the disclosure provided herein, one of ordinary skill in the art will recognize that the source data structures may be associated with various different data sources. Indeed, the source data structures and target data structure may all exist on the same physical medium, each on distinct physical media, or some on the same physical media and others on distinct physical media.

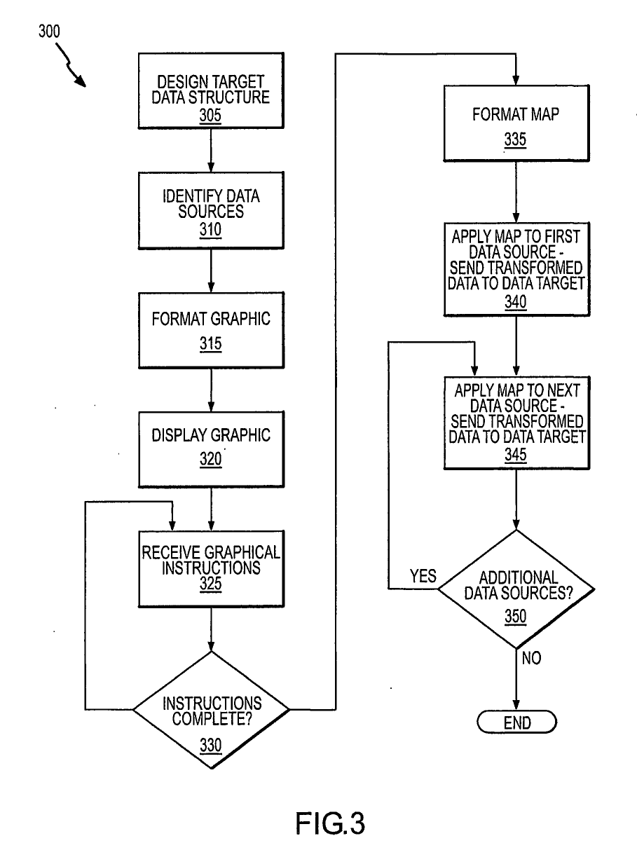

Turning now to FIG. 3, a flow diagram 300 illustrates a method for data exchange in accordance with one or more embodiments of the present invention. Following flow diagram 300, a target data structure is designed (block 305). Design of the target data structure may be done using one or more approaches known in the art. In one particular case, designing the target data structure includes providing a data element name via a graphical user interface. In addition to the element name, a relationship of the element to other elements is also received. In doing so, a target data structure such as target data structure 240 can be developed. In such a case for example, data element names X, X.1 and Y, among others are received. In addition, a relationship of X to X.1 and Y is received enabling the implementation of the target data structure. Based on the disclosure provided herein, one of ordinary skill in the art will appreciate a variety of methods and tools that may be used to design a target data structure.

Various data sources that include information that can be used to populate the target data store are also identified (block 310). Selection of the data sources may include selection of two or more data sources depending upon the level of distribution exibited by the information that is to be included in the target data structure. Selection may be done by putting in location information about the data source. For example, where one of the data sources is a public database accessible via the Internet, identifying a data source may include providing a URL address of the data source. Alternatively, where the data source is a proprietary data source available on a hard disk drive associated with a computer implementing the method, identifying the data source may include identifying a file holding the data source. Based on the disclosure provided herein, one of ordinary skill in the art will recognize a variety of methods by which data sources may be identified in accordance with one or more embodiments of the present invention.

A graphic is formatted that includes the designed target data structure displayed in relation to source data structures identified as the data sources (block 315). Thus, for example, two or more source data structures may be displayed to the left of the target data source. The individual elements of the source data structures and target data structure are displayed in such a way that the individual elements may be graphically connected one to another. Via the aforementioned graphic (block 315), graphical instructions may be received that connect particular elements of the various data structures (block 325). It is also determined whether all instructions have been received (block 330). Where reception of the instructions is not yet complete (block 330), additional instructions are received (block 325).

Alternatively, where reception of the instructions is complete (block 330), a map is formatted based on the previously received graphical instructions (block 335). The map includes a list of corresponding data elements including a data element from a source data structure that corresponds to (i.e., is mapped) an element of the target data structure. Where, for example, the target data structure includes ten elements, the map will include ten entries, with each of the ten entries identifying a source data element corresponding to a particular data element of the target data structure. Data is then merged from the data source to the target in accordance with the map (block 340). Thus, for example, where the map indicates that an element of one source data structure corresponds to a first element of the target data structure, then the first instance of the particular data element of the source data structure is accessed. This first instance is transferred and stored as the first instance of the corresponding data element of the target data store. This process is repeated for the second instance, with the second instance from the source data structure being stored as a second instance of the corresponding data element of the target data store. This process is continued until all instances of the particular data element have been transferred from the data source to the target data store. The process is then repeated for the next element and/or data sources, and for all instances thereof (block 345, 350). Once all of the elements and instances thereof have been merged, the process ends.

Where the number of instances is not the same for each of the data elements, or where the instances are not properly aligned, some alignment may be done. For example, where the first instance of a data element is the name FRED, and the first instance of the second data element is an employee number of JACK and the second instance of the second data element is the employee number for FRED some algorithm capable of assuring that the target data store is loaded with all of the information associated with FRED in one particular instance of the target data structure. Based on the disclosure provided herein, one of ordinary skill in the art will appreciate a variety of algorithms and/or methods that may be employed to assure that merges are aligned such that information in any particular instance of the target data structure are related.

Further, it should be noted at this juncture that while flow diagram 300 is particularly suited to transferring information from two or more data sources to a single data target, various embodiments of the present invention also provide for transferring information from one data source to multiple data targets, or from two or more data sources to two or more data targets. In some cases where data is being transferred to more than one target, data integrity is maintained by assuring that data is either supplied to all data targets or it is not supplied to any of the data targets. This may be achieved by extensive transaction support, which can rollback all data imported to any previous data target in the event that a tat transfer to a later data target identifies an error or inability to transfer particular data to another data target.

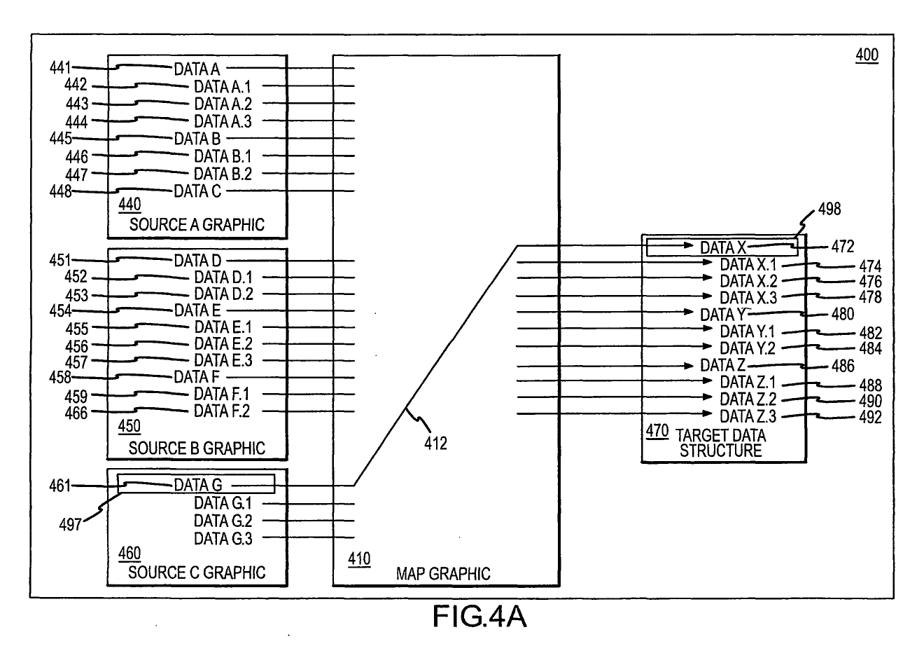

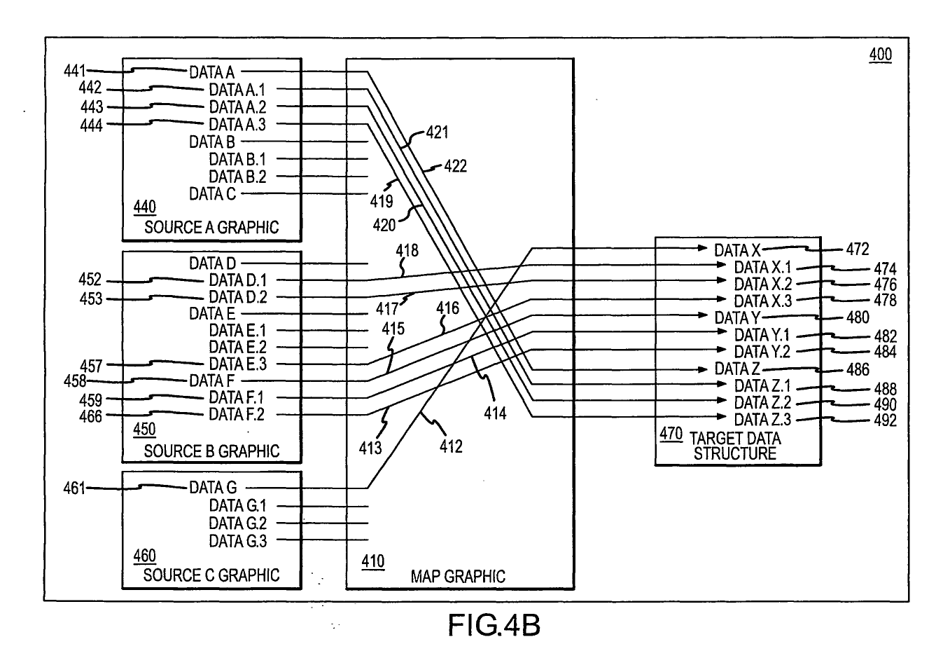

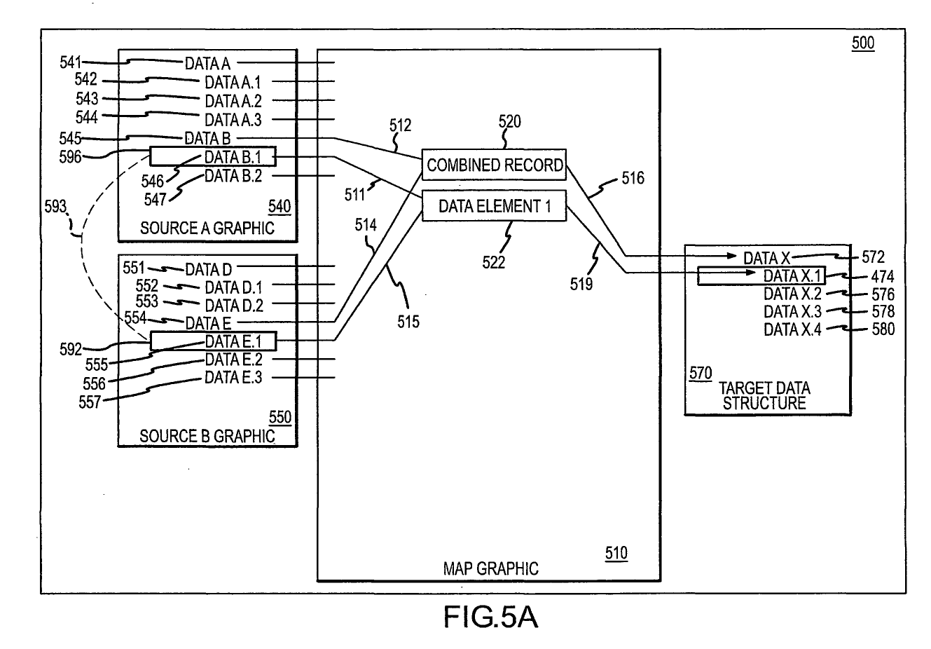

Turning to FIG. 4, a graphical tool 400 depicts a process consistent with the aforementioned flow diagram 300. Graphical tool 400 includes three graphical representations of data sources and source data structures associated therewith. In particular, graphical tool 400 displays a source A graphic 440 showing a source data structure including a data A element 441, a data A.1 element 442, a data A.2 element 443, a data A.3 element 444, a data B element 445, a data B.1 element 446, a data B.2 element 447 and a data C element 448. Graphical tool 400 displays a source B graphic 450 showing a source data structure including a data D element 451, a data D.1 element 452, a data D.2 element 453, a data E element 454, a data E.1 element 455, a data E.2 element 456, a data E.3 element 457, a data F element 458, a data F.1 element 459, and a data F.2 element 466. Graphical tool 400 displays a source C graphic 460 showing a source data structure including a data G element 461, a data G.1 element 462, a data G.2 element 463, and a data G.3 element 464. Graphical tool 400 also displays a target data structure 470 including a data X element 472, a data X.1 element 474, a data X.2 element 476, a data X.3 element 478, a data Y element 480, a data Y.1 element 482, a data Y.2 element 484, a data Z element 486, a data Z.1 element 488, a data Z.2 element 490, and a data Z.3 element 492.

In operation, a map graphic 410 is formed by selecting one of the source data elements and a corresponding target data element. Thus, as an example shown by FIG. 4A, data element G 460 is selected. This selection may be achieved by a mouse click on the graphically displayed data element G 461. Selecting data element G 461 causes a box 497 to be displayed around data element G 461 indicating that it has been used. In addition, data element X 472 is selected in a similar fashion causing a box 498 to be presented around data element X 472. With a source data element and a target data element selected, a line 412 is displayed connecting the corresponding data elements. Selection of the corresponding data elements and display of a line between the corresponding data elements is one example of a graphical instruction process that may be used in accordance with block 325 of the aforementioned flow diagram 300.

Turning to FIG. 4B, a completed version of map graphic 410 is displayed. Map graphic 410 is created by progressively selecting an element of target data structure 470 and a corresponding element of one of the data sources as described in relation to FIG. 4A above. In particular, map graphic 410 includes a line 413 between data element F.2 452 and data element Y.2 484; a line 414 between data element F.1 452 and data element Y.1 482; a line 415 between data element E.3 457 and data element X.3 478; a line 416 between data element F 458 and data element Y 480; a line 417 between data element D.2 457 and data element X.2 476; a line 418 between data element D.1 452 and data element X.1 474; a line 419 between data element A.3 444 and data element Z.3 492; a line 420 between data element A.2 443 and data element Z.2 490; a line 421 between data element A.1 442 and data element Z.1 488; and a line 422 between data element A 441 and data element Z 486.

As will be appreciated from the preceding discussion, systems and methods in accordance with the present invention may be used to address various situations. For example, where a data set is stored across multiple data sources, it may be merged into a new single or multiple data target. A particular implementation of the aforementioned example may include merging information related to employees in an Organization A that is spread across different databases and an XML file. Where, for example, Organization A is taken over by an Organization B which stores information about its employees is some different format, one or more embodiments of the present invention is able to extract information about the employees of Organization A and populate the extracted information in the appropriate fields of a database previously limited to employee information of Organization B. From this, a comprehensive employee report may be generated as, for example, an XML report. Alternatively, embodiments of the present invention may be used to provide a comprehensive employee report spanning Organization A and Organization B without formally merging the databases.

As another example, where a data set is stored in a data source and one or more fields of the data source contain information that is in a different format and can be parsed by some software program, one or more embodiments of the present invention may be tailored to extract information from the data source as well as identify the format of the information. A particular implementation of the aforementioned example may include taking a database with a table called “EMPLOYEES”. The table includes details (e.g., performance related data) in an XML file about each employee that is stored in a column of the table entitled “DETAILS”. One or more embodiments of the present invention may be used to generate an XML file containing all the information about all employees.

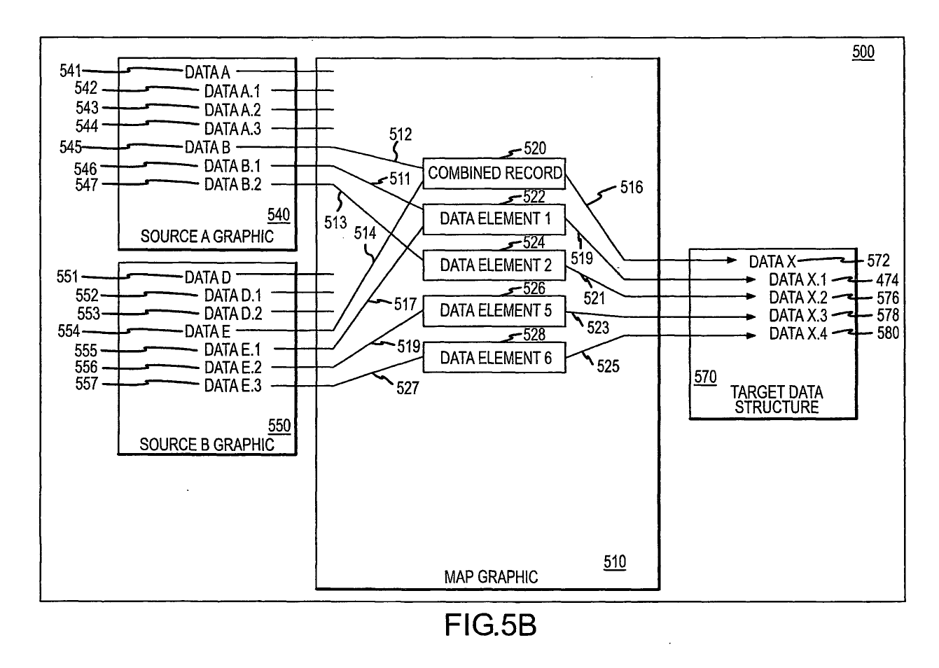

Turning to FIG. 5, another aspect of some embodiments of the present invention is described in relation to a graphical tool 500. In particular, the aspect provides for identifying data elements from two or more different data sources, and providing information associated with the identified data elements to a common data element of a data target. Thus, as an example, one data record (data B record 545) may include, as one example, the employee compensation information, while another data record (data E record 554) includes employee contact information. In the first data record the employee information may be gathered in association with a data element “EMPLOYEE_ID” (data B.1 element 546), while in the second data record the employee information is gathered in association with a data element “EMP” (data element E.1 555). In such a case, information associated with EMPLOYEE_ID and EMP are both gathered to be associated with a common data element in the data target. In particular, where EMPLOYEE_ID is “000001” and EMP “000001”, all of the information associated with employee number 000001 is combined into a common data structure.

Turning to FIG. 5A, graphical tool 500 includes two graphical representations of data sources and records associated therewith. In particular, graphical tool 500 displays a source A graphic 540 showing a source data structure including a data A record 541, a data A.1 element 542, a data A.2 element 543, a data A.3 element 544, data B record 545, a data B.1 element 546, and a data B.2 element 547. Graphical tool 500 displays a source B graphic 550 showing a source data structure including a data D record 551, a data D.1 element 552, a data D.2 element 553, data E record 554, a data E.1 element 555, a data E.2 element 556, and a data E.3 element 557. Graphical tool 500 also displays a target data structure 570 including a data X record 572, a data X.1 element 574, a data X.2 element 476, a data X.3 element 578, and a data X.4 element 580. Graphical tool 510 also includes a map graphic 510.

In FIG. 5A, a combined data record 520 is identified by name and type, causing a representation thereof to be displayed in map graphic 510. In addition, one or more data records (e.g., data B record 545, data E record 554 and data X record 572) are selected for association with combined data record 520. The association of data records is shown by lines 512, 514 and 516, respectively. This process of association is continued for associating the various data elements of the data sources with the data elements of the target. For example, data B.1 element 546 and data E.1 element 555 both include employee numbers and therefore are to be associated with the same virtual data element 522. To do this, a name and a type for virtual data element 522 is provided causing a graphical block to be displayed representing the virtual data element. In addition, one or more source data elements (e.g., data B.1 element 546 and data E.1 element 555) are selected. This selection can be done by using a mouse, or by some other approach. When the selection occurs, a box 596 is displayed around data B.1 element 546, and another box 592 is displayed around data E.1 element 555. Relating two or more source data elements with data element 522 indicates that the source data elements are associated with information of the same type, and as such may be used as a guide for combining the data represented by source A graphic 540 with that of source B graphic 550. This commonality between data B.1 element 546 and data E.1 element 555 is indicate by a dashed line 593. Thus, using the aforementioned example, data B.1 element 546 may be EMPLOYEE_ID, and data E.1 element 555 may be EMP. Where the data in the EMPLOYEE_ID field is the same type as the data in the EMP field, the data associated with the data elements may be aggregated under a common element—data X.1 element 574. As in both cases data B record 545 and data E record 554 include employee related information, they are gathered under a common data X record 572.

Turning to FIG. 5B, the process of aggregating data under a common data record is shown. The sub-elements associated with data B record 545 and the sub-elements associated with data E record 554 are mapped to sub-elements of data X record 572. In particular, data B.1 element 546 and data E.1 element 555 are mapped to data X.1 element 574 via virtual data element 522 as shown by a line 511, a line 517, and line a 519. Data B.2 element 547 is mapped to data X.2 element 576 via a virtual data element 524 as shown by a line 513 and a line 521. Data E.2 element 556 is mapped to data X.3 element 578 via a virtual data element 526 as shown by a line 519 and a line 523. Data E.3 element 557 is mapped to data X.4 element 580 via a virtual data element 528 as shown by a line 527 and a line 525. This map may be completed by selecting a source data element and a corresponding target data element for each of the mappings, and similar to that described in relation to FIG. 5A.

Based on the created map graphic 510, information from source A graphic 540 and source B graphic 550 may be gathered and reassembled as data X record 572 of target data structure 570. This process can include accessing the first instance of data B record 545 including the information maintained as data B.1 element 546 of the first record, and sorting through the instances of data E.1 elements 555 from data E record 554 to find a match to the first instance of data B.1 element 546. Once a match is found between data B.1 546 and data E.1 555, the instance of data B.1 element 546 and data B.2 element 547 corresponding to the first instance of data B record 545; and the instance of data E.2 element 556, and data E.3 element 557 corresponding to the found instance of data E.1 element 555 are transferred to a common instance of respective sub-elements of data X record 572 in accordance with map graphic 510. This process continues with accessing the second instance of data B record and finding the next match between data B.1 element 546 and data E.1 element 555, and continues until all instances of data B.1 element 546 of data B record 545 have been considered. This process yields a unified target database.

As one of many examples, data B.1 element 546 may be EMPLOYEE_ID as used above, and data B.2 element 547 may be compensation information about the employees identified in the field EMPLOYEE_ID. Similarly, data E.1 element 555 may be EMP as used above, and data E.2 element 556 and data E.3 element 557 may be contact information, names and other identification information about the employees identified in the field EMP. Once the transfer is complete, data X record 572 includes the employee ID from data B.1 element 546, and the compensation information and identification information from the respective sub-elements of data B record 545 and data E record 554.

In conclusion, the present invention provides novel systems, methods and arrangements for exchanging data. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A method for data exchange, the method comprising:
identifying a target data receptacle;
identifying a first source data receptacle;
identifying a second source data receptacle; and
providing a map, wherein the map includes a relationship between a first source element of the first source data receptacle and a first target element of the target data receptacle; and wherein the map includes a relationship between a second source element of the second source data receptacle and a second element of the target data receptacle.

2. The method of claim 1, wherein the method further comprises:
designing the target data receptacle, wherein designing the target data receptacle includes providing a name for the first target element and providing a name for the second target element.

3. The method of claim 2, wherein designing the target data receptacle further includes providing a relationship between the first target element and the second target element.

4. The method of claim 1, wherein the target data receptacle is an XML file defined by an XML schema.

5. The method of claim 1, wherein the method further comprises:
providing a graphical interface, wherein the graphical interface depicts a representation of the target receptacle, a representation of the first source receptacle, and a representation of the second source receptacle.

6. The method of claim 5, wherein the method further comprises:
receiving an instruction via the graphical interface to map the second source element of the second source data receptacle to the second element of the target data receptacle.

7. The method of claim 6, wherein the instruction is a first instruction, and wherein the method further comprises:
receiving a second instruction via the graphical interface to map the first source element of the first source data receptacle to the first element of the target data receptacle.

8. The method of claim 5, wherein the map is formed based at least in part on the instruction.

9. The method of claim 1, wherein the method further comprises:
applying the map, wherein information from the first source data receptacle is transferred to the target receptacle in accordance with the map, and wherein information from the second source data receptacle is transferred to the target receptacle in accordance with the map.

10. A system for exchanging data, the system comprising:
a microprocessor;
a computer readable medium accessible to the microprocessor, wherein the computer readable medium includes instructions executable by the microprocessor to:
receive an indication of a target data receptacle;
receive an indication of a first source data receptacle;
receive an indication of a second source data receptacle; and
provide a map, wherein the map includes a relationship between a first source element of the first source data receptacle and a first target element of the target data receptacle; and wherein the map includes a relationship between a second source element of the second source data receptacle and a second element of the target data receptacle.

11. The system of claim 10, wherein the target data receptacle is an XML file defined by an XML schema.

12. The system of claim 10, wherein the computer readable medium further includes instructions executable by the microprocessor to:
provide a graphical interface, wherein the graphical interface depicts a representation of the target receptacle, a representation of the first source receptacle, and a representation of the second source receptacle.

13. The system of claim 12, wherein the computer readable medium further includes instructions executable by the microprocessor to:
receive an instruction via the graphical interface to map the second source element of the second source data receptacle to the second element of the target data receptacle.

14. The system of claim 13, wherein the instruction is a first instruction, and wherein the computer readable medium further includes instructions executable by the microprocessor to:
receive a second instruction via the graphical interface to map the first source element of the first source data receptacle to the first element of the target data receptacle.

15. The system of claim 12, wherein the map is formed based at least in part on the instruction.

16. The system of claim 10, wherein the computer readable medium further includes instructions executable by the microprocessor to:
receive a design for the target data receptacle, wherein the design for the target data receptacle includes a name for the first target element and a name for the second target element.

17. The system of claim 16, wherein the design for the target data receptacle further includes a relationship between the first target element and the second target element.

18. The system of claim 10, wherein the computer readable medium further includes instructions executable by the microprocessor to:
apply the map, wherein information from the first source data receptacle is transferred to the target receptacle in accordance with the map, and wherein information from the second source data receptacle is transferred to the target receptacle in accordance with the map.

19. A method for data exchange, the method comprising:
identifying a target data receptacle;
identifying a first and a second source data receptacle;
providing a map, wherein the map includes a relationship between a first source element of the first source data receptacle and a first target element of the target data receptacle; and wherein the map includes a relationship between a second source element of the second source data receptacle and a second element of the target data receptacle; and
providing a graphical interface, wherein the graphical interface depicts a representation of the target receptacle, a representation of the first source receptacle, and a representation of the second source receptacle.

20. The method of claim 19, wherein the method further comprises:
receiving a first instruction via the graphical interface to map the second source element of the second source data receptacle to the second element of the target data receptacle; and
receiving a second instruction via the graphical interface to map the first source element of the first source data receptacle to the first element of the target data receptacle.
